(19) United States
(12) Patent Application Publication
(10) Pub. No.: US 2013/0319647 A1
(43) Pub. Date: Dec. 5, 2013

(54) METHOD FOR PRODUCING AN EXHAUST-GAS HEAT EXCHANGER

(71) Applicant: Benteler Automobiltechnik GmbH, Paderborn (DE)

(72) Inventors: Thorsten Andres, Paderborn (DE); Eugen Aul, Hameln (DE); Fabian Fricke, Paderborn (DE); Sebastian Müller, Willebadessen-Peckelsheim (DE); Rainer Voesgen, Salzkotten (DE)

(21) Appl. No.: 13/907,170

(22) Filed: May 31, 2013

(30) Foreign Application Priority Data
May 31, 2012 (DE) 10 2012 104 707.3

(51) Int. Cl. B23P 15/26

(52) U.S. Cl. CPC B23P 15/26
USPC 165/185; 205/640; 205/661; 205/645; 204/192.32; 204/192.33

(57) ABSTRACT

In a method of producing an exhaust-gas heat exchanger of a motor vehicle, at least one component of the exhaust-gas heat exchanger, e.g. an outer jacket or ducts arranged in the outer jacket or metal sheets, is subjected to an electrochemical machining process to produce a homogenous and smooth surface. The electrochemical machining process may involve plasma-polishing or electro-polishing.

### CROSS-REFERENCES TO RELATED APPLICATIONS

This application claims the priority of German Patent Application, Serial No. 10 2012 104 707.3, filed May 31, 2012, pursuant to 35 U.S.C. 119(a)-(d), the content of which is incorporated herein by reference in its entirety as if fully set forth herein.

### BACKGROUND OF THE INVENTION

The present invention relates to a method of producing an exhaust-gas heat exchanger, and to an exhaust-gas heat exchanger.

The following discussion of related art is provided to assist the reader in understanding the advantages of the invention, and is not to be construed as an admission that this related art is prior art to this invention.

Exhaust-gas heat exchangers are produced from corrosion-resistant metallic material in particular. Examples include special steels which do not rust and are able to withstand encountered exhaust temperatures of sometimes more than 1000° C. over an extended period so that the exhaust-gas heat exchanger does not wear off. To date, combustion engines are required to reduce a burden on the environment, in particular when used in motor vehicles. For that purpose, exhausts produced by the combustion engine are recirculated to the combustion process so as to reduce the content of nitrogen oxides in the exhaust by increasing the inert gas proportion to thereby lower the combustion temperature and thus emission of nitrogen oxide. The recirculated exhaust contains particles which deposit on the inner wall surfaces of the exhaust-conducting ducts, including ducts of the exhaust-gas heat exchanger. This process is called sooting. The deposit of particles on the inner wall surfaces of the exhaust-conducting ducts and also in particular of the channels of the exhaust-gas heat exchanger causes an increase in the exhaust gas back pressure. On one hand, the cross sections available for the flow are decreased, and on the other hand the flow resistance rises on the inner wall surfaces as a result of the particles deposited there and the resultant increase in the surface roughness. Furthermore, the presence of an additional soot layer deteriorates heat transfer, causing ultimately an increase in NOx emissions.

To counteract contamination or sooting, proposals have been made to coat the inner surfaces of the exhaust-gas heat exchanger. These coatings are produced for example with non-stick finish or the like. The application of such a coating process is disadvantageous because it increases production costs and the initial surface treatment deteriorates during use of the exhaust-gas heat exchanger, as the coating for example gradually is stripped or disappears entirely during use because it is not temperature-resistant.

It would therefore be desirable and advantageous to provide an improved method of producing an exhaust-gas heat exchanger to obviate prior art shortcomings and to provide a surface which is resistant to sooting and at the same time to lower the exhaust gas back pressure generated by the exhaust-gas heat exchanger while maintaining the efficiency of the exhaust-gas heat exchanger constant over its service life and allowing production of the exhaust-gas heat exchanger in a cost-effective manner.

### SUMMARY OF THE INVENTION

According to one aspect of the present invention, a method includes subjecting at least one component of an exhaust-gas heat exchanger of a motor vehicle to an electrochemical machining process to produce a homogenous and smooth surface. The component of the exhaust-gas heat exchanger may hereby be an outer jacket, or ducts arranged in the outer jacket, or metal sheets.

An exhaust-gas heat exchanger of a type involved here may for example be configured as a cartridge-like heat exchanger which includes an outer jacket, lids to close off the jacket, and duct systems or channels arranged in the jacket. The channels may, for example, be tube or tube bundles or plates layered on top of one another. Turbulators or metal sheets may then be placed into the plates or tubes to assume a flow guiding function or surface enlargement.

According to another advantageous feature of the present invention, the electrochemical machining process may include plasma-polishing or electro-polishing. As a result, the surfaces of individual components, in particular exhaust-conducting surfaces, are treated by the method of the present invention. These surfaces are homogenized, especially smoothened, to such an extent that soot particles or other contaminations are substantially prevented from adhering to the surfaces. In particular, the inner surfaces are treated by the electrochemical machining process. The machining process enables a lesser pressure loss within the heat exchanger, with an optionally subsequently applied coating decreasing sooting to thereby create a barrier between the metallic material of the heat exchanger and the conducting exhausts.

According to another advantageous feature of the present invention, the exhaust-gas heat exchanger may be subjected in its entirety to the electrochemical machining process.

According to another advantageous feature of the present invention, the exhaust-gas heat exchanger may be made from shaped metal sheets. Thus, sheet-metal blanks are used to form single metal sheets through application of a forming process, e.g. sheet metal forming process in a sheet metal press. The single metal sheets receive a three-dimensionally shaped surface structure capable of providing an improved heat transfer as a fluid flowing across the metal sheets generates turbulence. The metal sheets are hereby produced from a sheet metal blank through a forming process and then surface-treated by the electrochemical machining process, e.g. an electro-polishing process.

According to another advantageous feature of the present invention, the electrochemical machining process may involve electro-polishing having an acid bath, with the component serving as an anode. Duration or intensity of the electro-polishing process may be selected in dependence on a degree of shaping of the metal sheets. Duration relates hereby to the time in which the component, e.g. the metal sheet, is treated in the acid bath. Intensity depends on the selection of the acid bath or introduced additives and on the applied voltage during electro-polishing. Both factors, i.e. duration or intensity, are advantageously selected as a function of the shaping degree. The forming process causes cracks or micro-cracks on the surface, in particular when sheet-metal blanks are involved. Electro-polishing is then selected in such a way as to ablate the surface based on the most pronounced cracks to the desired level so that cracks in the surface are no longer present or at least reduced to an insignificant level. Through electro-polishing, 70%, preferably 80%, and even more than 90% of crack lengths, extending on the surface to the component middle, can be eliminated from the surface of the component.

According to another advantageous feature of the present invention, the surface of the component may evenly be stripped by electro-polishing by using a chemical additive in the acid bath. In particular, the surface of the three-dimensionally formed component is evenly stripped. Metal sheets produced in this way are thus not weakened at positive or negative corners, thereby ensuring sufficient strength of the component after undergoing electro-polishing.

According to another advantageous feature of the present invention, the surface of the component can have a mean roughness depth of less than 1.5 μm as a result of electro-polishing. As an alternative or in addition, the component can have a surface tension between 30 and 40 mN/m, in particular 36 to 38 mN/m. Realization of such a surface characteristic has proven beneficial to achieve good heat transfer, best conditions for applying an optional coating on the surface and for a soldering operation for coupling individual components, especially of metal sheets, with one another.

The surface is of optimal quality in particular with respect to particles that are encountered during combustion of combustion engines, such as Otto engines and/or diesel engines, so as to prevent the particles to adhere to the surface. The surface roughness is reduced by the electrochemical machining process which is also referred to as electrochemical smoothing. This process decreases micro-roughness of the metallic surface. Roughness peaks are more rapidly removed than roughness valleys. Overall, fine deburring is realized, even of those regions that border roughness valleys so that particles in the exhaust are impeded from depositing on the exhaust-conducting surface of the exhaust-gas heat exchanger. In addition, particles that may adhere can easily be removed by greater mass flows in view of the slight adhesive forces.

Of course, it is also possible within the scope of the invention to subject pipelines, corrugated sheets, or the entire heat exchanger, for example in the form of a heat exchanging cartridge, to an electrochemical machining process in accordance with the present invention. As a result, the entire exhaust-gas heat exchanger may be electro-polished for example.

Components that undergo electrochemical machining are initially pretreated, especially cleansed and degreased. Advantageously, the components are chemically pretreated and then subjected to the electrochemical machining process in an immersion bath. The immersion bath may be an acid bath, advantageously a phosphor mixture acid bath or a sulfur mixture acid bath, in which the components are immersed. Voltage is applied, advantageously between 3 and 15 V, to the component as anode, and in combination with a cathode, advantageously several cathodes, also provided in the immersion bath, a respective polishing process or surface stripping is implemented, resulting in electro-polishing. Metal ions are removed electrolytically from the surface of components being treated.

The component may also undergo plasma polishing as electrochemical machining process. Plasma polishing enables immersion of components in an immersion bath comprised of a saline solution mixture, wherein a significantly higher voltage can be applied as opposed to electro-polishing. A plasma film is guided about the component, causing again a removal of metal ions and thus a smoothing of the surface. A gas flow is hereby generated as a result of a localized gas development of the electrolyte at a small electrode to cover the entire surface of the component and thereby enable formation of a plasma skin. As a result, micro-roughness is leveled and deburred, and organic and inorganic contaminations on the surface are removed. Plasma polishing eliminates the need for a preliminary intensive cleansing of the component so that a pretreatment step is eliminated and thus production costs are decreased.

The respectively treated surface has a mean roughness depth of less than 1.5 μm. Examples of used materials that undergo electrochemical machining include stainless steel types: 1.4301, 1.4306, 1.4307, 1.4521, 1.4509, 1.4401, 1.4404.

According to another advantageous feature of the present invention, the surface of the component may be coated after the component underwent the electrochemical machining process. In particular exhaust-conducting surfaces are coated. For example, it is possible to provide the treated surface with a ceramic coating or also with gel coat which is then burnt into the surface. Other examples of coatings include an antiskid coat or a glass-ceramic coat, in particular a silicon oxide layer.

The presence of a coating prevents exhaust or particles in the exhaust to soot on the surface of the component. As a result of the greatly diminished sooting or even total elimination of sooting, it is thus possible in accordance with the present invention to ensure high heat transfer during operation of a thus-produced motor vehicle heat exchanger, in particular when used of an extended period.

According to another advantageous feature of the present invention, single components may be soldered with one another after the electrochemical machining process. Examples of soldering include inert gas soldering or vacuum soldering. Inert gas soldering is advantageously carried out in the presence of a 100% H₂ atmosphere at a dew point of essentially −40° C. Solder temperature may hereby range between 980° C. to 1100° C. A benefit is hereby that oxygen-affine constituents of the base material do not oxidize so as to enable an optimal application of a coating after inert gas soldering.

As an alternative, high-vacuum soldering of 10⁻³ to 10⁻⁷ mbar may be carried out, also at a soldering temperature between 980° C. to 1100° C. The same benefits are hereby attained with respect to oxidation of constituents of the base material when applying vacuum soldering.

According to another advantageous feature of the present invention, the component may be weighed to determine a starting weight before the component is subjected to the electrochemical machining process. The component after undergoing the electrochemical machining process can have a weight which is 85 to 99.8% of the starting weight, especially 90 to 99.5%, preferably 95 to 99%.

According to another aspect of the present invention, an exhaust-gas heat exchanger for a motor vehicle includes an outer jacket, and ducts arranged in the outer jacket, wherein at least one of the outer jacket and the ducts is subjected to an electrochemical machining process to produce a homogenous and smooth surface.

An exhaust-gas heat exchanger according to the present invention may be made of special steel, for example of a material type 1.4301. At least exhaust-conducting surfaces of the component are smoothed or polished by electrochemical machining so that particles flowing during operation of the combustion engine through the exhaust-gas heat exchanger are prevented from adhering to the surface. In particular, the removal of surface peaks on the surface being treated is realized, especially a deburring of surface craters. Advantageously, the entire exhaust-gas heat exchanger undergoes electrochemical machining.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a perspective illustration of a metal sheet produced by a method according to the present invention for use in an exhaust-gas heat exchanger;

FIG. 2 is a perspective detailed view, on an enlarged scale, of a metal sheet; and

FIGS. 3a and 3b are schematic illustrations of a surface stripping using electro-polishing.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

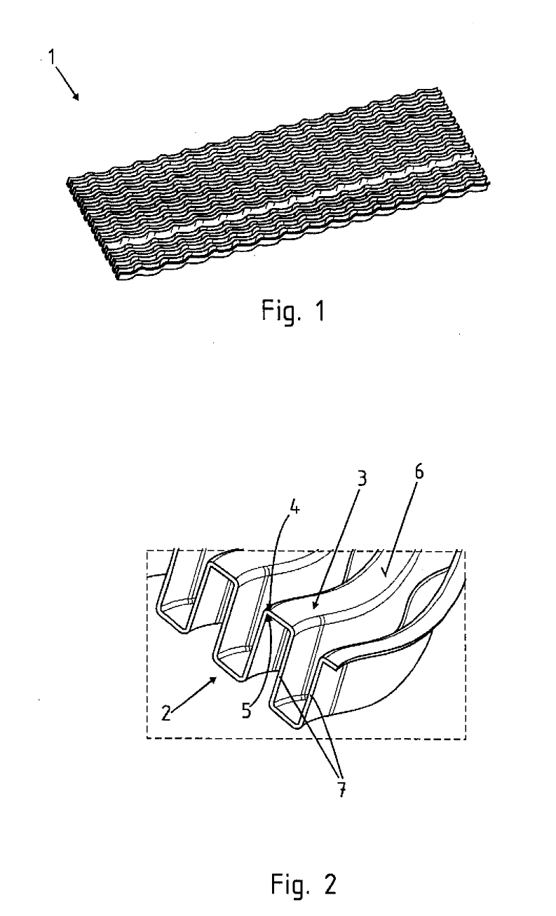

Turning now to the drawing, and in particular to FIG. 1, there is shown a perspective illustration of a metal sheet 1, here a corrugated metal sheet, produced by a method according to the present invention for use in an exhaust-gas heat exchanger. In the case of a heat exchanger cartridge which later is inserted into an exhaust-gas heat exchanger, plural metal sheets 1 are suitably produced by initially forming the metal sheets 1 separate from one another and undergoing electrochemical machining and then are stacked and soldered with one another.

FIG. 2 shows a perspective detailed view, on an enlarged scale, of the metal sheet 1 to depict wave valleys 2 and wave crests 3. Positive corners 4 and negative corners 5 are configured between the wave valleys 2 and the wave crests 3. Applying an electrochemical machining process in accordance with the present invention, e.g. electro-polishing, provides an even ablation of the entire surface 6 of the metal sheet 1. As a result, the regions of the wave valleys 2 or wave crests 3 and regions of webs 7 located between the wave valleys 2 and the wave crests 3 as well as the regions of the positive and negative corners 4, 5 are ablated in the absence of any significant variations. Thus, the surface is evenly stripped.

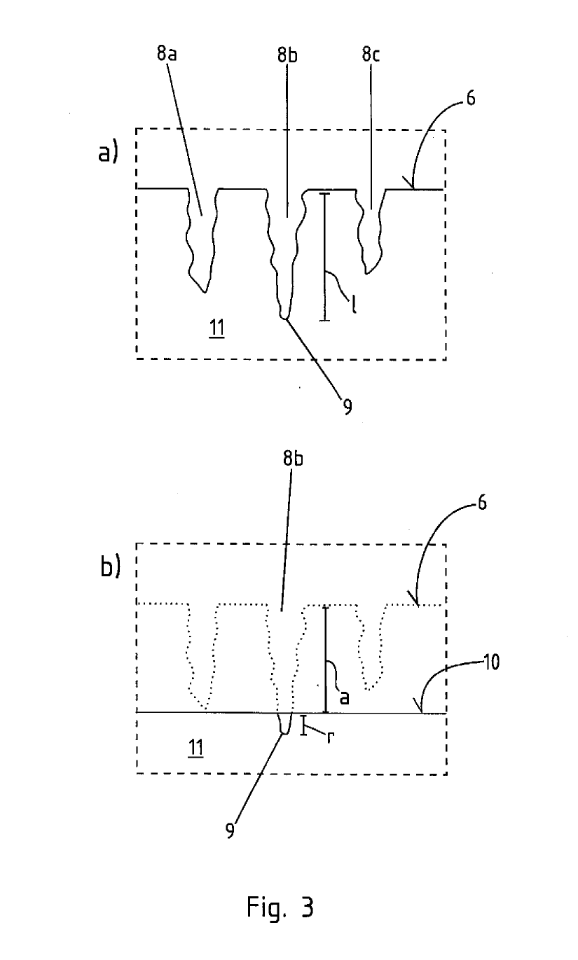

FIG. 3a shows the shaped surface 6 before undergoing electrochemical machining and FIG. 3b shows the shaped surface 6 after undergoing electrochemical machining. According to FIG. 3a, micro-cracks or cracks 8a, 8b, 8c have formed on the surface 6 as a result of the forming .process. By electrochemical machining, e.g. electro-polishing, the surface is ablated by a measure a. Only the middle crack 8b is still present with its peak 9 in the ablated surface 10. Cracks, 8a, 8c have been entirely removed by electro-polishing. The extent for the surface ablation a is hereby in the example of FIG. 3 about 90% of a length l of the longest crack 8b extending from the surface 6. Thus, a length r of the crack peak 9 remains which extends from the surface 10 in direction of a component middle 11 after undergoing electro-polishing. This, however, satisfies desired surface quality, especially with an averaged roughness depth Rz of less than 1.5 μm.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method, comprising subjecting at least one component of an exhaust-gas heat exchanger of a motor vehicle to an electrochemical machining process to produce a homogenous and smooth surface.

2. The method of claim 1, wherein the component is at least one member of the exhaust-gas heat exchanger selected from the group consisting of outer jacket and ducts arranged in the outer jacket.

3. The method of claim 1, wherein the electrochemical machining process includes plasma-polishing or electro-polishing.

4. The method of claim 2, wherein the component is an exhaust conducting one of the ducts subjected to electro-polishing as electrochemical machining process.

5. The method of claim 1, wherein the exhaust-gas heat exchanger in its entirety is subjected to electro-polishing as electrochemical machining process.

6. The method of claim 1, wherein the electrochemical machining process involves electro-polishing having an acid bath, with the component serving as an anode.

7. The method of claim 6, wherein the acid bath is at least one of a phosphor mixture acid bath and a sulfur mixture acid bath.

8. The method of claim 1, further comprising shaping metal sheets as the component in a forming process, and subjecting the shaped metal sheets to an electro-polishing process as electrochemical machining process.

9. The method of claim 6, wherein the surface of the component is evenly stripped by electro-polishing by using an additive in the acid bath.

10. The method of claim 8, further comprising selecting a duration or intensity of electro-polishing as a function of a degree of shaping of the metal sheets.

11. The method of claim 1, further comprising weighing the component to determine a starting weight before the component is subjected to the electrochemical machining process.

12. The method of claim 11, wherein the component after undergoing the electrochemical machining process has a weight which is 85 to 99.8% of the starting weight, especially 90 to 99.5%, preferably 95 to 99%.

13. The method of claim 1, wherein the surface of the component has a mean roughness depth of less than 1.5 μm.

14. The method of claim 1, wherein the component has a surface tension between 30 and 40 mN/m, in particular 36 to 38 mN/m.

15. The method of claim 1, further comprising coating the surface of the component with an antiskid coat or a glass-ceramic coat after the component underwent the electrochemical machining process.

16. The method of claim 1, further comprising soldering a plurality of said component after the plurality of components underwent the electrochemical machining process.

17. The method of claim 16, wherein soldering involves inert gas soldering or vacuum soldering.

18. An exhaust-gas heat exchanger for a motor vehicle; comprising:
an outer jacket; and
ducts arranged in the outer jacket, wherein at least one of the outer jacket and the ducts is subjected to an electrochemical machining process to produce a homogenous and smooth surface.
